(19) United States
(12) Patent Application Publication
(10) Pub. No.: US 2016/0275719 A1
(43) Pub. Date: Sep. 22, 2016

(54) SYSTEM AND METHOD FOR FAST OPTIMIZATION OF POINT CLOUD DATA

(71) Applicant: Intergraph Corporation, Madison, AL (US)

(72) Inventor: David William Oke, Exeter (CA)

(21) Appl. No.: 14/662,396

(22) Filed: Mar. 19, 2015

(51) Int. Cl. G06T 17/00

(52) U.S. Cl. CPC G06T 17/005

(57) ABSTRACT

A system and method for fast optimization of point cloud data utilizes a point cloud indexer process and an octree class process running in parallel. The point cloud indexer process is configured to build an octree and associated index from a point cloud dataset. The octree class process is configured to run in parallel with the point cloud indexer process and is configured to serve data at a lowest level of detail directly from the point cloud dataset when a request for lowest level of detail is received from the client and the point cloud indexer process is still building the octree and index

### FIELD OF THE INVENTION

The present invention relates generally to fast optimization of point cloud data, and more specifically to serving data while building an octree for multidimensional data.

### BACKGROUND OF THE INVENTION

A point cloud is a set of data points in a given coordinate system. In a three-dimensional coordinate system, the data points are typically defined by X, Y, and Z coordinates and typically represent the external surface of an object, such as may be captured by a 3D scanner, LIDAR, or other capturing technique. The data points may be associated with additional information, such as, for example, color information, intensity information, resolution information, or other metadata. Often, a point cloud will contain a large number of data points (e.g., hundreds of millions). One commonly-used file format for storing point cloud data records is the LAS file format, which is described, for example, in LAS SPECIFICATION VERSION 1.4-R13, American Society for Photogrammetry and Remote Sensing, 15 Jul. 2013, which is hereby incorporated herein by reference in its entirety.

Optimizing point cloud data into an index structure is a fairly common practice. For example, TerraExplorer's MakeCPT function can be used to optimize point cloud data into an index structure, although the inventors found that this optimization method required a preprocess step and did not offer the versatility of being able to connect to the data in the original LAS point cloud data file. Also, LASTools' LASIndex function can be used to optimize point cloud data into an index structure, although the inventors found that this optimization method also required a preprocess step and uses quad-trees.

The inventors also investigated Wang et al., “An Integrated Spatial Indexing of Huge Point Image Model,” International Archives of the Photogrammetry, Remote Sensing and Spatial Information Sciences, Volume XXXIX-B4, 2012, XXII ISPRS Congress, 25 August—01 Sep. 2012, Melbourne, Australia, which is designed around an idea for a Quad-MBB tree to effectively index the point cloud as an 2d image or as a 3d point cloud. The method for 3D point indexing organizes data into leaf nodes contained within a QMBB structure.

It is known to represent and organize three-dimensional data using octrees, for example, as discussed in U.S. Pat. No. 4,694,404 (Meagher) and in Meagher, D.,

Geometric Modeling Using Octree Encoding, Computer Graphics and Image Processing 19, 129-147 (1982).

### SUMMARY OF EXEMPLARY EMBODIMENTS

One embodiment of the present invention includes a system for fast optimization of point cloud data. The system comprises a point cloud indexer process configured to build an octree and associated index from a point cloud dataset and an octree class process that runs in parallel with the point cloud indexer process and is configured to serve data at a lowest level of detail directly from the point cloud dataset when a request for lowest level of detail is received from the client and the point cloud indexer process is still building the octree and index.

Another embodiment of the present invention includes a method for fast optimization of point cloud data. The method involves running a point cloud indexer process configured to build an octree and associated index from a point cloud dataset and running an octree class process that runs in parallel with the point cloud indexer process and is configured to serve data at a lowest level of detail directly from the point cloud dataset when a request for lowest level of detail is received from the client and the point cloud indexer process is still building the octree and index.

In various alternative embodiments of the system and method, the octree class process may be configured to perform sequential sampling across the entire point cloud dataset to gather the required samples for the data at the lowest level of detail when a request for lowest level of detail is received from the client and the point cloud indexer process is still building the octree and index. The octree class process may be configured to use the completed octree and index to fulfill a request for other than the lowest level of detail, for example, by waiting until the point cloud indexer process completes building the octree and index when a request for other than the lowest level of detail is received from the client and the point cloud indexer process is still building the octree and index, or by blocking or suspending the octree class process until the point cloud indexer process completes building the octree and index when a request for other than the lowest level of detail is received from the client and the point cloud indexer process is still building the octree and index.

In certain embodiments, the point cloud indexer process may be configured to determine a number of levels of detail for the octree and index and to build the octree and index to the determined number of levels of detail. The point cloud indexer process may be configured to store the octree in a cache memory and may be configured to create a level-of-detail file for each of the number of levels of detail.

In certain embodiments, the point cloud indexer process and the octree class process are hardware processes, while in other embodiments, the point cloud indexer process and the octree class process are software process running in a computer system. Additional embodiments may be disclosed and claimed.

### BRIEF DESCRIPTION OF THE DRAWINGS

The foregoing features of embodiments will be more readily understood by reference to the following detailed description, taken with reference to the accompanying drawings, in which:

FIG. 1 is a schematic block diagram of a LAS point cloud processing system in accordance with one exemplary embodiment of the present invention;

FIG. 2 is a schematic diagram of an exemplary octree node with point data populated within the node;

FIG. 3 is a schematic diagram showing the octree node of FIG. 2 logically divided into eight potential sub-nodes with one of the sub-nodes null/absent because no data fell within the sub-node;

FIG. 4 is a schematic diagram for an exemplary parent node at LOD 9 encompassing all of the sub-nodes shown in FIG. 3;

FIG. 5 is a schematic diagram for the child nodes at LOD 10 encompassing the individual sub-nodes shown in FIG. 3;

FIG. 6 is a logic flow diagram for a Parallel Process A, in accordance with one exemplary embodiment; and

FIG. 7 is a logic flow diagram for a Parallel Process B, in accordance with one exemplary embodiment.

It should be noted that the foregoing figures and the elements depicted therein are not necessarily drawn to consistent scale or to any scale. Unless the context otherwise suggests, like elements are indicated by like numerals.

### DETAILED DESCRIPTION OF SPECIFIC EMBODIMENTS

Embodiments of the present invention are directed to optimization and display of large un-optimized LAS point cloud data files. Generally speaking, LAS files are large and can contain hundreds of millions of points. Un-optimized LAS data can quickly exhaust computer system resources, and optimization techniques available today can take a long time to complete. Embodiments of the present invention achieve very fast indexing speed by scanning the data once and creating an octree index structure. Importantly, embodiments of the present invention allow data for the lowest level of detail to be served while index construction is taking place. This indexing can take place in-line of data load and does not require the user to manually pre-process the data.

Unlike the indexing described in the Wang paper, which is mentioned in the background, embodiments of the present invention use an octree, only store an index into the original LAS point cloud data, and do not use any compression. Therefore, embodiments of the present invention do not have to duplicate data that is already available in the LAS file.

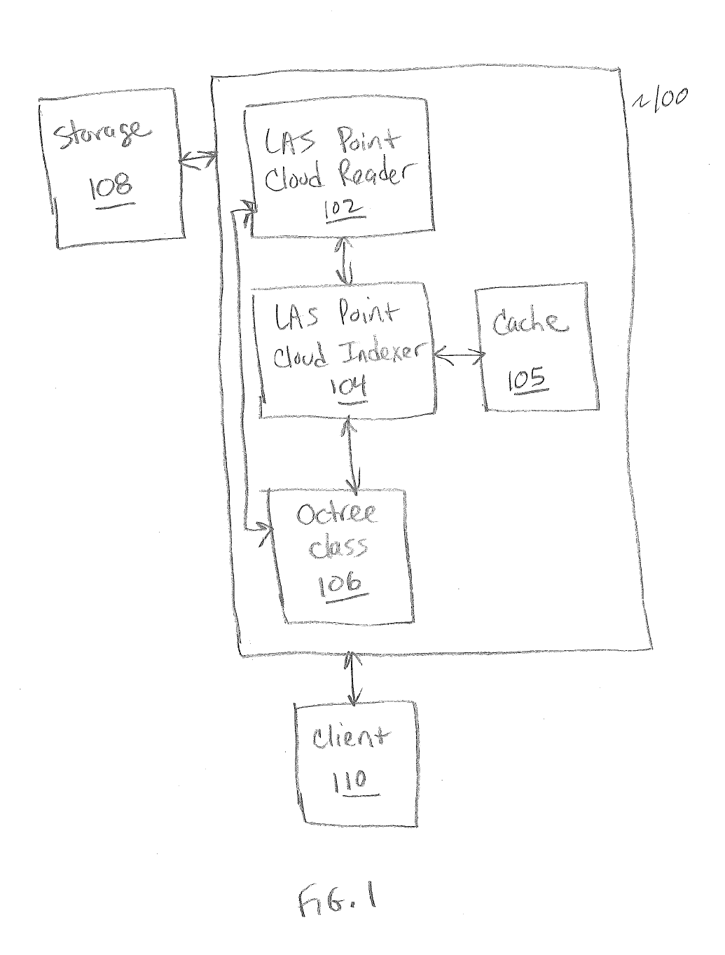

FIG. 1 is a schematic block diagram of a LAS point cloud processing system 100 in accordance with one exemplary embodiment of the present invention. The system 100 is typically a server that is accessed by one or more clients over a communication system. Among other things, the system 100 includes an LAS point cloud reader 102, an LAS point cloud indexer 104, and an octree class 106.

The LAS point cloud reader 102 is responsible for reading LAS files from storage 108 and is used by all of the other components in the system.

The LAS point cloud indexer 104 uses the LAS point cloud reader 102 to perform a single scan of the LAS data and generate an index optimized into an octree, which, in one exemplary embodiment, is stored in cache memory 105 for fast access to the octree and index.

The octree class 106 is the main controller and client interface for the system 100. The octree class 106 receives request for LAS data from the client 110. If the client 110 requests the lowest detailed node and the octree has not yet been built, then the octree class 106 causes the LAS point cloud indexer 104 to start indexing the LAS data and at the same time performs a sequential sample using the LAS point cloud reader 102 to gather the required set of points.

The client 110 accesses the octree via the octree class 106 in order to retrieve a set of indexes for a given octree node. The client then uses the list of indexes to directly retrieve via the LAS point cloud reader 102 the actual LAS data (e.g., XYZ, Intensity, RGB values, etc.).

The exemplary embodiment described below will allow the user to quickly visualize the un-optimized LAS point cloud data without having the user perform a pre-processing step. Several steps are done, some in parallel, to complete this process. In this exemplary embodiment, the LAS point cloud indexer 104 and the octree class 106 run as parallel processes in a computer system, although these components may be implemented in hardware or even on separate devices in various alternative embodiments. For convenience, the LAS point cloud indexer 104 process is referred to below as “Parallel Process A” while the octree class 106 process is referred to below as “Parallel Process B.”

Parallel Process A

1. Determine if cached octree and level of detail files exist.

This process first determines if a cached octree and level of detail (LOD) files exist for the given input point cloud. If these files do not exist, then the process begins indexing the data, as follows.

2. Determine recommended levels of detail.

In order to build the octree, the process determines a lowest level of detail for the dataset and also determines the number of levels of detail (LOD) for the octree. In this exemplary embodiment, the process determines the recommended levels of detail for the octree, which may be overridden by the user. In order to determine the recommended levels of detail for the octree, the process takes the total number of points in the point cloud dataset and right bit-shifts two positions (i.e., divides by 4) until a value is reached that is less than or equal to a predetermined maximum point count per node (PCPN). One exemplary embodiment uses a default PCPN value of 32000, although alternative embodiments may use different PCPN values, and the PCPN value may be configurable to allow the user to decide the number of points per level of detail (LOD) block. The number of iterations for this process to complete will become the recommended levels of detail, which as mentioned above, may be overridden by the user. The following is pseudocode for determining the recommended levels of detail for the octree, in accordance with one exemplary embodiment.

```
recommendedLevelsOfDetail = 1;
pointCount initially is defined as the total
number of points in the LAS dataset.
while (pointCount > idealPointsPerBlock)
    {
    pointCount >>= 2;
    recommendedLevelsOfDetail++;
    }
```

3. Build the octree structure and index the data.

The process then builds the octree structure and indexes the data. In this exemplary embodiment, the process determines (in base 2) the lowest level of detail for the dataset based on the min x/max x delta, and the min y/max y delta. For example, if the row delta is 800 and the column delta is 400, then the maximum base 2 value is 1024 for the row parameter and 512 for the columns. In this case, the value 1024 will be used, as it is the maximum value, and the log base 2 value for this number (10) will be the lowest level of detail.

The system then uses the “levels of detail” value to determine the highest level of detail for the dataset. For example, if the lowest level of detail for a given dataset is determined to be 10, and the levels of detail is determined to be 4, then the octree will contain 4 levels of detail from levels 7 (highest) through 10 (lowest). In this case, the x/y/z size of an octree node at Level 10 (lowest) would be 1024, the x/y/z size of an octree node at Level 9 would be 512, the x/y/z size of an octree node at Level 8 would be 256, and the x/y/z size of an octree node at Level 7 (highest) would be 128.

With this information, the process generates metadata for an initial set of nodes based on the highest level of detail and then scans the point cloud data into an initial set of nodes, as follows:

i. Generate metadata for an initial set of nodes based on the highest level of detail. The nodes themselves will not be created unless point cloud data falls within that node. The objects in this list will eventually contain the level of detail ID, and X/Y/Z indexes. This is done so any subsequent processing will be able to determine where these blocks belong in relation to one another in a single level of detail. The metadata includes:

Row count and column count

Maximum row/column count based on the lowest level of detail value determined above.

The limit on the level of detail. In an exemplary embodiment, this is calculated by subtracting the lowest level of detail value by the levels of detail value determined above and adding one. For example, if the lowest level of detail value is 10 and the levels of detail value is 4, then the resulting highest level of detail index will be 7.

ii. Scan the point cloud data and bin the data into an initial set of nodes. These nodes represent a location in 3D space. The initial set of nodes contains a collection of indexes that point to a unique record in the LAS file. Each node also contains a point count of the total number of stored indexes. A node will only be created if points fall within the node; otherwise the node will remain set to null.

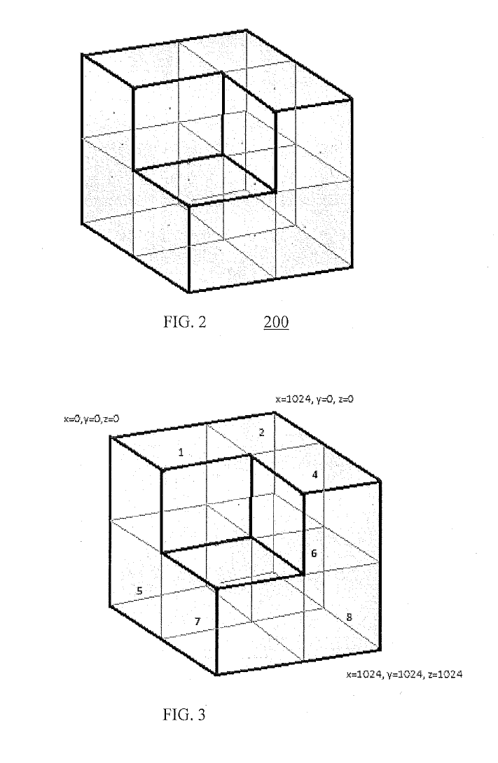

FIG. 2 is a schematic diagram of an exemplary octree node 200 with point data populated within the node. The node 200 can be logically divided into eight potential sub-nodes, as represented and numbered in FIG. 3. In this example, one of the sub-nodes is null/absent, as no data fell within the sub-node.

The node, as well as each sub-node, is associated with an XYZ index. This index spatially places the node and sub-nodes within the octree and facilitates searching for a specific node or sub-node during the rendering process when the index is fully built. In the example shown in FIG. 3, the node and sub-node indexes are as follows:

The Node and Sub-Node 1 would be assigned the following index values:

XLevelIndex: 0

YLevelIndex: 0

ZLevelIndex: 0

Sub-Node 2 would be assigned the following index values:

XLevelIndex: 512

YLevelIndex: 0

ZLevelIndex: 0

Sub-Node 4 would be assigned the following index values:

XLevelIndex: 512

YLevelIndex: 512

ZLevelIndex: 0

Sub-Node 5 would be assigned the following index values:

XLevelIndex: 0

YLevelIndex: 0

ZLevelIndex: 512

Sub-Node 6 would be assigned the following index values:

XLevelIndex: 512

YLevelIndex: 0

ZLevelIndex: 512

Sub-Node 7 would be assigned the following index values:

XLevelIndex: 0

YLevelIndex: 512

ZLevelIndex: 512

Sub-Node 8 would be assigned the following index values:

XLevelIndex: 512

YLevelIndex: 512

ZLevelIndex: 512

The null/absent sub-node would have been assigned the following index values:

XLevelIndex: 0

YLevelIndex: 512

ZLevelIndex: 0

In addition to the index values, each node and sub-node is associated with an extent and a level identifier. In the example shown in FIGS. 2 and 3, the extent for the node is 1024, and the extent for each sub-node is 512. The level identifier for each node and sub-node is based on the log base 2 value of the its respective extent. For the entire node 200, since extent is 1024, the level identifier would be 10 (i.e., 1024=2̂10). For each sub-node, since the extents are 512, the level identifier would be 9 (i.e., 512=2̂9).

4. Generate levels of detail from this initial set of nodes.

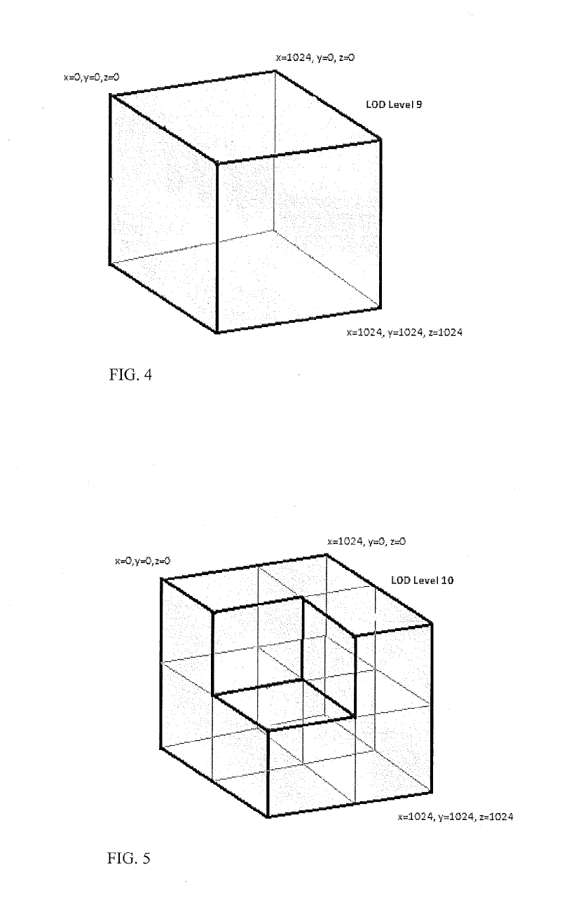

The process then generates levels of detail from the initial set of nodes. The first task to be performed is to generate a set of parents for the input node list. The parent nodes will have their level-of-detail (LOD) decremented by 1. FIG. 4 is a schematic diagram for the parent node at LOD 9 encompassing all of the sub-nodes shown in FIG. 3, while FIG. 5 is a schematic diagram for the child nodes at LOD 10 encompassing the individual sub-nodes shown in FIG. 3.

The process loops though each input node and assigns each one a parent. In the end of this process, every parent is assigned up to eight child nodes. The parent node will cover the same combined area extent as its child nodes, and the parent's point count will be populated such that it represents the combined point count of its child nodes.

The process then loops though the parent nodes and examines if any point re-distribution should take place. If the aggregated point count associated with the parent node is less than or equal to the PCPN value, then all of the data from the child nodes are aggregated into the parent node and all of the child nodes are then set to null. This parent node is now considered to have the highest level of detail.

If, instead, the aggregated point count associated with the parent node is greater than the PCPN value, then the process performs an even sampling of data across the child nodes. The goal is to sample PCPN points for the parent. An optional step can then be done to remove duplicate points from the child nodes.

Once sampling is completed, the system writes the point indexes of all of the parent node's child nodes to a LOD file. After this data is written, the child nodes, along with their point indexes, are released to conserve memory.

Now that a new set of parent nodes is created, the system starts over and recursively applies this process until there is just one parent node.

Once this process is complete, the block (if any) created in Parallel Process B (described below) is released and data can be served for higher level of detail nodes.

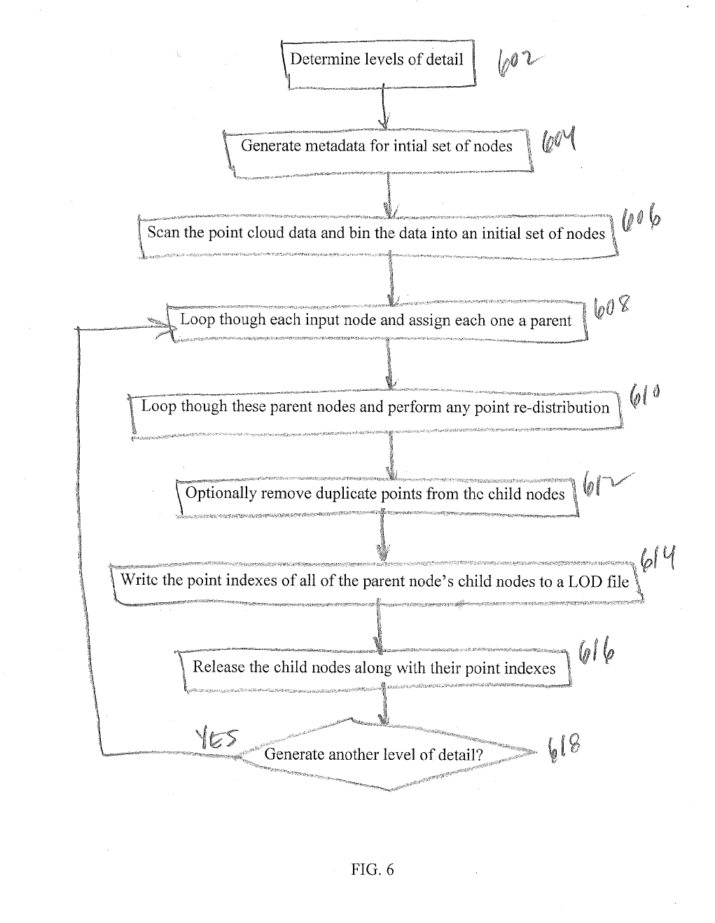

FIG. 6 is a logic flow diagram for Parallel Process A, in accordance with one exemplary embodiment. In block 602, the logic determines the levels of detail for the octree and index. This may involve determining a recommended levels of detail, which may be overridden by the user. The logic then recursively builds the octree structure and indexes the data. Specifically, starting in block 604, the logic generates metadata for an initial set of nodes, and, in block 606, scans the point cloud data and bins the data into an initial set of nodes. The logic then generates levels of detail from the initial set of nodes by looping through each input node and assigning each one a parent, in block 608, looping through these parent nodes and performing any point re-distribution, in block 610, optionally removing duplicate points from the child noes, in block 612, writing the point indexes of all of the parent node's child nodes to a LOD file, in block 614, and optionally releasing the child nodes along with their point indexes, in block 616. If the logic determines that another level of detail is needed in block 618, then the logic recycles to block 608 and uses the parent nodes from the previous iteration as the input nodes for the next iteration.

Parallel Process B

If the client makes a request for the first (or lowest) level of detail while the octree/index is in the process of being built, then this process performs a sequential sampling across the entire LAS dataset to gather the required number of samples and returns the samples to the client, e.g., to be displayed while the rest of the octree is being built. This ability for the lowest level of detail to be served while index construction is taking place is considered to be a key aspect of the invention, as the inventors believe that prior art systems require the LOD index to be completely built before data is served to the user. If a request is made for a deeper level of detail while the octree/index is in the process of being built, then Parallel Process B is suspended, blocked, or otherwise waits until Parallel Process A completes construction of the octree/index, at which time Parallel Process B serves data to the client from the indexed data.

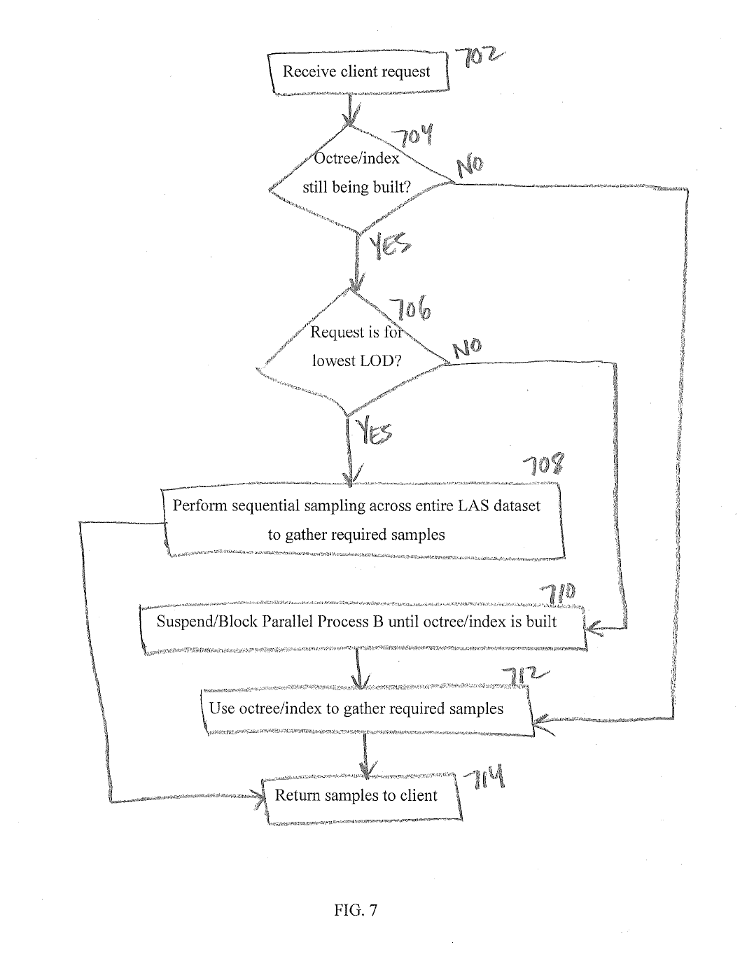

FIG. 7 is a logic flow diagram for Parallel Process B, in accordance with one exemplary embodiment. In block 702, the process receives a client request. In block 704, the process determines if the octree/index is still in the process of being built. If the octree/index is complete (NO in block 704), then the process proceeds to block 712, where the process uses the octree/index to gather required samples and then returns the samples to the client in block 714. If, however, the octree/index is still in the process of being built (YES in block 704), then the logic determines if the request is for the lowest level of details, in block 706. If the request is for the lowest level of detail (YES in block 706), then the process performs sequential sampling across the entire LAS dataset to gather the required samples and then returns the samples to the client in block 714. If, however, the request is not for the lowest level of detail (NO in block 706), then the logic proceeds to block 710 where the process is suspended/blocked until the octree/index is complete, at which time the process proceeds to block 712, where the process uses the octree/index to gather required samples and then returns the samples to the client in block 714.

### Miscellaneous

It should be noted that arrows may be used in drawings to represent communication, transfer, or other activity involving two or more entities. Double-ended arrows generally indicate that activity may occur in both directions (e.g., a command/request in one direction with a corresponding reply back in the other direction, or peer-to-peer communications initiated by either entity), although in some situations, activity may not necessarily occur in both directions. Single-ended arrows generally indicate activity exclusively or predominantly in one direction, although it should be noted that, in certain situations, such directional activity actually may involve activities in both directions (e.g., a message from a sender to a receiver and an acknowledgement back from the receiver to the sender, or establishment of a connection prior to a transfer and termination of the connection following the transfer). Thus, the type of arrow used in a particular drawing to represent a particular activity is exemplary and should not be seen as limiting.

It should be noted that terms such as “client” and “server” (e.g., in the context of FIG. 1) may be used herein to describe devices that may be used in certain embodiments of the present invention and should not be construed to limit the present invention to any particular device type unless the context otherwise requires. Thus, a device may include, without limitation, a server, computer, appliance, or other type of device. Such devices typically include one or more network interfaces for communicating over a communication network and a processor (e.g., a microprocessor with memory and other peripherals and/or application-specific hardware) configured accordingly to perform device functions. Communication networks generally may include public and/or private networks; may include local-area, wide-area, metropolitan-area, storage, and/or other types of networks; and may employ communication technologies including, but in no way limited to, analog technologies, digital technologies, optical technologies, wireless technologies (e.g., Bluetooth), networking technologies, and internetworking technologies.

It should also be noted that devices may use communication protocols and messages (e.g., messages created, transmitted, received, stored, and/or processed by the device), and such messages may be conveyed by a communication network or medium. Unless the context otherwise requires, the present invention should not be construed as being limited to any particular communication message type, communication message format, or communication protocol. Thus, a communication message generally may include, without limitation, a frame, packet, datagram, user datagram, cell, or other type of communication message. Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should also be noted that logic flows may be described herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof Computer program logic implementing some or all of the described functionality is typically implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAs.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “process” refers generally to the execution of a set of computer program instructions regardless of whether different computer processes are executed on the same or different processors and regardless of whether different computer processes run under the same operating system process/thread or different operating system processes/threads.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

Importantly, it should be noted that embodiments of the present invention may employ conventional components such as conventional computers (e.g., off-the-shelf PCs, mainframes, microprocessors), conventional programmable logic devices (e.g., off-the shelf FPGAs or PLDs), or conventional hardware components (e.g., off-the-shelf ASICs or discrete hardware components) which, when programmed or configured to perform the non-conventional methods described herein, produce non-conventional devices or systems. Thus, there is nothing conventional about the inventions described herein because even when embodiments are implemented using conventional components, the resulting devices and systems (e.g., the system 100 described herein) are necessarily non-conventional because, absent special programming or configuration, the conventional components do not inherently perform the described non-conventional methods.

The present invention may be embodied in other specific forms without departing from the true scope of the invention, and numerous variations and modifications will be apparent to those skilled in the art based on the teachings herein. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A system for fast optimization of point cloud data, the system comprising:
a point cloud indexer process configured to build an octree and associated index from a point cloud dataset; and
an octree class process that runs in parallel with the point cloud indexer process and is configured to serve data at a lowest level of detail directly from the point cloud dataset when a request for lowest level of detail is received from the client and the point cloud indexer process is still building the octree and index.

2. A system according to claim 1, wherein the octree class process is configured to perform sequential sampling across the entire point cloud dataset to gather the required samples for the data at the lowest level of detail when a request for lowest level of detail is received from the client and the point cloud indexer process is still building the octree and index.

3. A system according to claim 2, wherein the octree class process is configured to use the completed octree and index to fulfill a request for other than the lowest level of detail.

4. A system according to claim 3, wherein the octree class process is configured to wait until the point cloud indexer process completes building the octree and index when a request for other than the lowest level of detail is received from the client and the point cloud indexer process is still building the octree and index.

5. A system according to claim 3, wherein the octree class process is blocked or suspended until the point cloud indexer process completes building the octree and index when a request for other than the lowest level of detail is received from the client and the point cloud indexer process is still building the octree and index.

6. A system according to claim 1, wherein the point cloud indexer process is configured to determine a number of levels of detail for the octree and index and to build the octree and index to the determined number of levels of detail.

7. A system according to claim 6, wherein the point cloud indexer process is configured to store the octree in a cache memory.

8. A system according to claim 6, wherein the point cloud indexer process is configured to create a level-of-detail file for each of the number of levels of detail.

9. A system according to claim 1, wherein the point cloud indexer process and the octree class process are hardware processes.

10. A system according to claim 1, wherein the point cloud indexer process and the octree class process are software process running in a computer system.

11. A method for fast optimization of point cloud data, the method comprising:
running a point cloud indexer process configured to build an octree and associated index from a point cloud dataset; and
running an octree class process that runs in parallel with the point cloud indexer process and is configured to serve data at a lowest level of detail directly from the point cloud dataset when a request for lowest level of detail is received from the client and the point cloud indexer process is still building the octree and index.

12. A method according to claim 11, wherein the octree class process is configured to perform sequential sampling across the entire point cloud dataset to gather the required samples for the data at the lowest level of detail when a request for lowest level of detail is received from the client and the point cloud indexer process is still building the octree and index.

13. A method according to claim 12, wherein the octree class process is configured to use the completed octree and index to fulfill a request for other than the lowest level of detail.

14. A method according to claim 13, wherein the octree class process is configured to wait until the point cloud indexer process completes building the octree and index when a request for other than the lowest level of detail is received from the client and the point cloud indexer process is still building the octree and index.

15. A method according to claim 13, wherein the octree class process is blocked or suspended until the point cloud indexer process completes building the octree and index when a request for other than the lowest level of detail is received from the client and the point cloud indexer process is still building the octree and index.

16. A method according to claim 11, wherein the point cloud indexer is configured to determine a number of levels of detail for the octree and index and to build the octree and index to the determined number of levels of detail.

17. A method according to claim 16, wherein the point cloud indexer is configured to store the octree in a cache memory.

18. A method according to claim 16, wherein the point cloud indexer is configured to create a level-of-detail file for each of the number of levels of detail.

19. A method according to claim 11, wherein the point cloud indexer process and the octree class process are hardware processes.

20. A method according to claim 11, wherein the point cloud indexer process and the octree class process are software process running in a computer system.
